(19) United States
(12) Patent Application Publication
(10) Pub. No.: US 2008/0057191 A1
(43) Pub. Date: Mar. 6, 2008

(54) METHOD OF MANUFACTURING ULTRA-THIN SOFT CONDUCTIVE CLOTH

(75) Inventors: Feng-Chang Chang, Touliu (TW); Chih-Ming Cheng, Touliu (TW); Chun-Hung Lin, Touliu (TW)

Correspondence Address: CONNOLLY BOVE LODGE & HUTZ, LLP, P O BOX 2207, WILMINGTON, DE, 19899, US

(73) Assignee: Formosa Taffeta Co., Ltd., Touliu (TW)

(21) Appl. No.: 11/850,715

(22) Filed: Sep. 6, 2007

(30) Foreign Application Priority Data
Sep. 6, 2006 (TW) 095132883

(51) Int. Cl. B05D 3/12; B05D 5/10

(52) U.S. Cl. 427/208.8; 427/314; 427/316

(57) ABSTRACT

The present invention relates to a method of manufacturing an ultra-thin soft conductive cloth, which includes the steps of providing a cloth interwoven with artificial fibers, thermal calendering the cloth at least once to reduce the thickness and increase the softness, and electroless plating the thermal calendered cloth for metallization, so as to form the ultra-thin soft conductive cloth having electromagnetic shielding effect.

### BACKGROUND OF THE INVENTION

1. Field of the Invention

The present invention relates to a technical field of conductive cloth, and more particularly to a method of manufacturing an ultra-thin soft conductive cloth having electromagnetic shielding effect.

2. Description of the Prior Art

In view of the miniaturization trend of electronic products, conductive cloth used to prevent electromagnetic waves leaking from the electronic machine from affecting the electronic machine itself or other electronic machines and causing incorrect operations thereby, should be synchronously ultra-thinned and softened. Conventional conductive cloth can be made into conductive cloth tapes after being coated or laminated with conductive pressure-sensitive adhesives. If the conductive cloth is too thick and not soft enough, it significantly restricts the applications of the microminiaturized products since such products require low thickness and softness.

Currently, ultra-thin soft conductive fabrics are generally interwoven with specific yarns, for example, flat yarns having about 30 denier to about 80 denier, and a flat rate of about 2:1 to about 10:1, which results in cloth as thin as about 50 μm. Compared with the conductive cloth interwoven with common yarns of about 5 denier to about 150 denier and having a thickness of at least about 80 μm, the thickness of the ultra-thin soft conductive fabrics is reduced by about 60%, and a desirable softness is obtained. During the warping process of the yarns, the flat yarns are all required to be arranged in a flat and width-wise manner. During the interweaving process, if the flat yarns are arranged incorrectly in terms of width and height, the cloth surface will have irregular texture and the thickness will not meet the objective of the original design. Therefore, the flat yarns are costly and not easily interwoven, and the possibility of manufacturing fabrics of complex designs is restricted to a certain extent.

Since the current common conductive cloth is excessively thick and not soft enough, and the conductive cloth interwoven with flat yarns cannot be easily interwoven and is limited in design, their applications are restricted and improvements are necessary.

### SUMMARY OF THE INVENTION

In order to eliminate the restrictions and disadvantages of the current conductive cloth, an object of the present invention is to provide a method of manufacturing an ultra-thin soft conductive cloth.

The method of manufacturing an ultrathin soft conductive cloth of the present invention includes the steps of: providing cloth interwoven with artificial fibers; thermal calendering the cloth at least once; and electroless plating the thermal calendered cloth for metallization.

### DETAILED DESCRIPTION OF THE INVENTION

In a specific embodiment of the present invention, the method of manufacturing an ultra-thin soft conductive cloth includes the following steps: providing cloth interwoven with artificial fibers; after the process of scouring and cleaning, thermal setting, and surface roughening, thermal calendering the cloth at least once to reduce the thickness and to increase the softness; and after the surface adjusting process, electroless plating a metal layer of copper, nickel, silver, gold, or an alloy thereof uniformly on the surface of the cloth.

The artificial fibers used in the method can be any artificial fiber, for example, but not limited to, rayon fiber, nylon fiber, polyester fiber, or acrylic fiber, and preferably polyester fiber. The artificial fibers are about 5 denier to about 50 denier and interwoven into cloth having a thickness of about 70 μm to about 100 μm.

Scouring and cleaning and thermal setting processes of the cloth are performed in the conventional way. Surface roughening process can be performed by the well-known liquid alkali reduction process, in which the reduction ratio is about 5% to about 40%, and preferably about 10% to about 25%.

Thermal calendering process is performed by twisting and pressing the cloth with two or three rollers, which preferably include one rubber roller and one or two stainless steel rollers. Preferably, the thermal calendaring process is performed twice in the method of the present invention to reduce the thickness and to increase the softness of the cloth. In one embodiment of the present invention, the conditions for the thermal calendering process are as follows: the temperature is about 50° C. to about 230° C., and preferably about 130° C. to about 190° C.; the pressure is about 50 daN/cm to about 500 daN/cm, and preferably about 150 daN/cm to about 300 daN/cm; the calendar speed is about 5 M/min to about 80 M/min, and preferably about 10 M/min to about 50 M/min.

In one embodiment of the present invention, the thermal calendered ultra-thin soft conductive cloth has a thickness of about 40 μm to about 60 μm.

The electroless plating process is well known to those skilled in the art, in which the metal used can be any metal having desirable conductivity, for example, but not limited to, copper, nickel, silver, gold, or an alloy thereof.

The ultra-thin soft conductive cloth manufactured according to the method of the present invention can be coated or laminated with a conductive pressure-sensitive adhesive to serve as a conductive cloth tape. In order to be conveniently used in final applications, the tape can be cut and wound, sliced, cut, and stamped to form an ultra-thin soft conductive cloth tape with a roll-shaped or sheet-shaped configuration, having anti-radiation and antistatic properties. It is capable of preventing the electromagnetic waves leaking from the electronic machine from affecting the electronic machine itself or other electronic machines and causing incorrect operations thereby.

In one embodiment of the present invention, the ultrathin soft conductive cloth in a roll-shaped configuration has a width of about 50 cm to about 180 cm, and preferably about 90 cm to about 155 cm, and is coated or laminated with a well-known conductive pressure-sensitive adhesive having a thickness of about 10 μm to about 60 μm, to form a conductive cloth tape. Then, after the cutting and winding, slicing, and cutting processes, an ultra-thin soft conductive cloth tape conveniently used for final applications is obtained, which has a thickness of about 50 μm to about 120 μm.

The examples given below are intended to be illustrative only and not to be limitations of the invention. Any modifications and variations that can be easily made by those skilled in the art fall within the scope of the disclosure of the specification and the appended claims of the present invention.

### EXAMPLES

An ultra-thin soft conductive cloth is manufactured according to the following steps.

Interweaving: Plainweave cloth having a thickness of about 81 μm is interwoven with polyester fibers having warp yarns 20 denier/24 filaments, weft yarns 30 denier/12 filaments, warp density 189 yarns/inch, and weft density 125 yarns/inch.

Surface roughening: At 80° C., the plainweave cloth is immersed in an aqueous solution of 20% sodium hydroxide for 15 min, and the reduction ratio is 15%.

Thermal calendering: At the temperature of 160° C., pressure of 230 daN/cm to 500 daN/cm and calendar speed of 25 M/min, the thermal calendering process is performed on the same surface of the plainweave cloth twice by a machine having two rollers, so as to reduce the thickness of the cloth to 50 μm.

Electroless plating: first, activation: at 30° C., the cloth is immersed in a solution of 100 mg/L palladium chloride, 10 g/L stannous chloride, and 100 ml/L hydrochloric acid for 3 min, and washed completely; next, acceleration: at 45° C., the cloth is immersed in 100 ml/L hydrochloric acid for 3 min, and washed completely; electroless plating of copper: at 40° C., the cloth is immersed in a solution of 10 g/L copper sulfate, 7.5 ml/L formaldehyde, 8 g/L sodium hydroxide, 30 g/L ethylene diamine tetraacetic acid tetrasodium salt (EDTA-4Na), and 0.25 ml/L stabilizer for 20 min, so as to uniformly plate 25 g/M² copper on the cloth, and then the cloth is washed completely; electroless plating of nickel: at 40° C., the cloth is immersed in a solution of 22.5 g/L nickel sulfate, 18 g/L sodium hypophosphite, 0.1 M/L sodium citrate, and 20 ml/L ammonia for 5 min, to uniformly plate 5 g/M² nickel on the cloth, and washed completely; and finally, the cloth is dried, to obtain a conductive cloth having a thickness of about 52 μm.

Laminating conductive pressure-sensitive adhesives: Double-sided release-liner non-base conductive pressure-sensitive adhesives having a thickness of 40 μm are laminated on the conductive cloth at the tension of 15 Kg and the speed of 20 M/min. As the conductive pressure-sensitive adhesives will partially permeate the material of the cloth, after the lamination, the total thickness of the conductive pressure-sensitive adhesives and the ultra-thin soft conductive cloth is about 70 μm. Then, after the cutting and winding, slicing, and cutting processes, a conductive pressure-sensitive cloth tape containing release-liner in the roll-shaped or sheet-shaped configuration is obtained.

In view of the above, the manufacturing method of the present invention merely needs to perform a thermal calendering process before electroless plating the cloth, so as to significantly reduce the thickness of the cloth, and after the electroless plating process, a thin and soft conductive cloth is obtained. Compared with the conventional cloth interwoven with flat yarns or other special yarns, the manufacturing method of the present invention is not only simple and cost-efficient, but also can be used to obtain ultra-thin soft conductive fabrics of complex designs, so it is quite helpful for expanding the application field of the conductive cloth.

What is claimed is:

1. A method of manufacturing an ultrathin soft conductive cloth, comprising:
providing cloth interwoven with artificial fibers;
thermal calendering the cloth at least once; and
electroless plating the thermal calendered cloth for metallization.

2. The manufacturing method as claimed in claim 1, wherein the artificial fibers comprise rayon fiber, nylon fiber, polyester fiber, or acrylic fiber.

3. The manufacturing method as claimed in claim 1, wherein the artificial fibers have a fineness of about 5 denier to about 50 denier.

4. The manufacturing method as claimed in claim 1, wherein the thermal calendered cloth has a thickness of about 40 μm to about 60 μm.

5. The manufacturing method as claimed in claim 1, wherein in the thermal calendering process, the temperature is about 50° C. to about 230° C., the pressure is about 50 daN/cm to about 500 daN/cm, and the calendar speed is about 5 M/min to about 80 M/min.

6. The manufacturing method as claimed in claim 1, wherein the electroless plating process comprises uniformly plating a metal layer of copper, nickel, silver, gold, or an alloy thereof on the surface of the cloth.

7. The manufacturing method as claimed in claim 1, wherein the resultant ultra-thin soft conductive cloth is coated or laminated with a conductive pressure-sensitive adhesive to serve as a conductive cloth tape.

8. The manufacturing method as claimed in claim 7, wherein the conductive cloth tape has a thickness of about 50 μm to about 120 μm.
